(19) United States
(12) Patent Application Publication
(10) Pub. No.: US 2025/0062567 A1
(43) Pub. Date: Feb. 20, 2025

(54) Electrical Connector with Terminal Protection Cover

(71) Applicants: TE Connectivity Solutions GmbH, Schaffhausen (CH); TE Connectivity India Private Limited, Bangalore (IN)

(72) Inventors: Lawrence John BREKOSKY, Middletown, PA (US); Ramesh S, Bangalore (IN); William G. LINDBERG, Elizabethtown, PA (US); Sreeraj KR, Bangalore (IN)

(73) Assignees: TE Connectivity Solutions GmbH, Schaffhausen (CH); TE Connectivity India Private Limited, Bangalore (IN)

(21) Appl. No.: 18/654,094

(22) Filed: May 3, 2024

(30) Foreign Application Priority Data
Aug. 17, 2023 (IN) 202341055101

(51) Int. Cl. H01R 13/52; H01R 13/506

(52) U.S. Cl. CPC H01R 13/5213; H01R 13/506

(57) ABSTRACT

A connector assembly having a connector housing with terminal receiving cavities which extend to a mating end of the connector housing. Electrical terminals are provided in the terminal receiving cavities. The terminals have mating portions which extend from the terminal receiving cavities beyond the mating end of the electrical connector. A movable cover is movably mounted on the connector housing. The movable cover extends over the mating portions of the terminals. The movable cover prevents unwanted engagement and damage to the mating portions of the terminals during shipping and assembly.

### REFERENCE TO PRIORITY

This application claims priority to and the benefit of Indian Patent Application No. 202341055101 filed Aug. 17, 2023, which is hereby incorporated by reference in its entirety.

### FIELD OF THE INVENTION

The invention relates to electrical connectors, and in particular is directed to a connector housing with a movable cover which protects ends of contact terminals which project from the connector housing prior to mating.

### BACKGROUND OF THE INVENTION

Electrical connectors, such as headers, are known in which electrical terminals are held in an insulative housing with mating portions of the terminals extending from the housing for insertion into corresponding through-holes of a substrate or circuit board. Prior to insertion into the through-holes, the mating portions are exposed and are not protected by the housing. This is particularly problematic during shipment and during assembly of the conductors to the conductor receiving portion of the terminals. During shipment and assembly, the mating portions may be bent or otherwise damaged, preventing the terminals and the electrical connector from properly mating with the circuit board.

It would, therefore, be beneficial to provide a connector housing with a cover which protects the substrate mating portions of the contact terminals during shipment and assembly. In particular, it would be beneficial to provide a cover which protects the substrate mating portions prior to mating and which is movable prior to or during mating to allow for proper mating of the mating portions of the terminals with the circuit board.

### SUMMARY OF THE INVENTION

The following provides a summary of certain illustrative embodiments of the present invention. This summary is not an extensive overview and is not intended to identify key or critical aspects or elements of the present invention or to delineate its scope.

An embodiment is directed to a connector assembly having a connector housing with terminal receiving cavities which extend to a mating end of the connector housing. Electrical terminals are provided in the terminal receiving cavities. The terminals have mating portions which extend from the terminal receiving cavities beyond the mating end of the electrical connector. A movable cover is movably mounted on the connector housing. The movable cover extends over the mating portions of the terminals. The movable cover prevents unwanted engagement and damage to the mating portions of the terminals during shipping and assembly.

In an illustrative embodiment, the movable cover has a first wall and side walls which extend from the first wall, the first wall and the side walls extend from the mating end a further distance than the mating portions of the terminals extend from the mating end of the connector housing when the movable cover is in an initial position.

In an illustrative embodiment, a latching projection is provided on the connector housing proximate the mating end. A first latch receiving opening and a second latch receiving opening extend through the first wall of the cover, the first latch receiving opening and the second latch receiving opening are spaced apart and are positioned in line with the latching projection.

In an illustrative embodiment, tracks are provided on side walls of the connector housing, the tracks extend from proximate the mating end. Recesses are provided on the side walls of the cover. In the illustrative embodiment, the tracks have a dovetail configuration in which sidewalls of the tracks are tapered inward toward the side walls. The recesses have a dovetail configuration and are configured to allow the tracks to be positioned therein, thereby allowing the tracks and the recesses to guide the cover as the cover is moved between a first latched position and a second latched position. However, other configurations of the tracks and recess may be used.

In an illustrative embodiment, the cover is initially attached to the connector housing by molded connection points which extend between ends of the cover and the mating end of the connector housing. The molding connection points provide a breakable connection between the cover and the connector housing to maintain the cover in an initial position relative to the connector housing.

In an illustrative embodiment, the connector housing has mounting guide projections which extend from the mating end and latching projections positioned between the mating end. The movable cover has a first wall, a second wall and side walls which extend between the first wall and the second wall. Latch receiving projections extend from the second wall of the cover. The latch receiving projections have latch receiving openings which extend therethrough. Mounting guide projection receiving openings extend from a leading surface of the cover toward a rear surface of the cover. The mounting guide projection receiving openings are dimensioned to receive the mounting guide projections therein.

Additional features and aspects of the present invention will become apparent to those of ordinary skill in the art upon reading and understanding the following detailed description of the illustrative embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more illustrative embodiments of the invention and, together with the general description given above and detailed description given below, serve to explain the principles of the invention, and wherein:

FIG. 1 is a front top perspective view of an illustrative connector assembly with a connector housing having a cover shown in a first molded position.

FIG. 2 is a rear bottom perspective view of the connector assembly shown in FIG. 1.

FIG. 3 is a top side perspective view of the connector assembly shown in FIG. 1.

FIG. 4 is a top perspective view of the illustrative connector assembly of FIG. 1 with the cover is shown in a first latching position to protect substrate mating portions of contact terminals positioned in the connector housing.

FIG. 5 is a front top perspective view of a second illustrative connector housing of a connector assembly having a cover shown in a first molded position,

FIG. 6 is a rear bottom perspective view of the connector housing shown in FIG. 5.

FIG. 7 is a top side perspective view of the connector housing shown in FIG. 5.

FIG. 8 is a front bottom perspective view of a third illustrative connector housing of a connector assembly.

FIG. 9 is a rear top perspective of the connector housing of FIG. 8,

FIG. 10 is a rear bottom perspective view of a cover which can be assembled to the connector housing of FIG. 8.

FIG. 11 is a rear bottom perspective view of the cover of FIG. 10 assembled to the connector housing of FIG. 8.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Illustrative embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

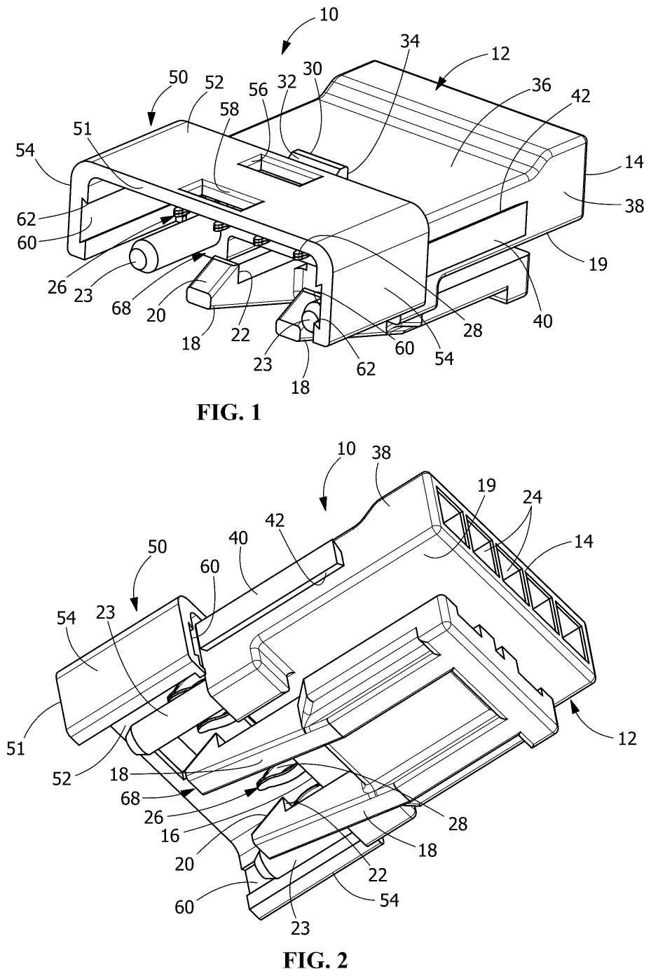

As shown in FIGS. 1 through 4, a first illustrative embodiment of a connector 10 has a connector housing 12 with a wire receiving end 14 and a substrate mating end 16. Latching arms 18 extend from proximate the wire receiving end 14 to beyond the substrate mating end 16. The latch arms 18 have lead-in surfaces 20 proximate free ends thereof. Latching shoulders 22 are provided proximate the lead-in surfaces 20. In the illustrative embodiment, two latching arms 18 are provided extending from a bottom or first wall 19 of the connector housing 12. However, other numbers and configurations of latching arms 18 may be used. In addition, the latching arms may be provided on an additional part which is mated with the connector housing.

Mounting guide projections 23 extend from the substrate mating end 16 in a direction away from the wire receiving end 14. In the illustrative embodiment, two mounting guide projections 23 are provided, however other numbers and configurations of the mounting guide projections 23 may be used.

The connector housing 12 has terminal receiving cavities 24 which extend from the wire receiving end 14 to the substrate mating end 16. Contact terminals 26 are positioned in the terminal receiving cavities 24. The contact terminals 26 have substrate mating portions 28 which extend beyond the substrate mating end 16. The contact terminals 26 may be, but are not limited to, the type of terminals described in copending U.S. application Ser. No. 17/382,842 filed Jul. 22, 2021 and copending U.S. application Ser. No. 18/336,091 filed Jun. 16, 2023, both of which are incorporate herein by reference in their entirety.

The connector housing 12 has a latching projection 30 positioned between the wire receiving end 14 and the substrate mating end 16. In the illustrative embodiment shown, the latching projection is provided proximate the substrate mating end 16. The latching projection 30 has a lead-in surfaces 32 and latching shoulders 34. In the illustrative embodiment, one latching projection 30 is provided on a top or second wall 36 of the connector housing 12 which is opposed to the first wall 19 from which the latching arms 18 extend. However, other numbers and configurations of the latching projection 30 may be used.

Side walls 38 extend between the first wall 19 and the second wall 36. A dovetail track 40 is provided on each side wall 38. The dovetail tracks 40 extend from proximate the substrate mating end 16 toward the wire receiving end 14. The dovetail tracks 40 have angled side walls 42 which are tapered inward toward the side walls 38. In the illustrative embodiment, the tracks 40 have a dovetail configuration, however, other configurations of the tracks 40 may be used.

A cover member 50 is provided proximate the substrate mating end 16 of the connector housing 12. The cover member 50 has a first planar wall 52 and side walls 54 which extend from the first wall 52. In the embodiment shown, the side walls 54 extend essentially perpendicular to the first wall 52. The cover member 50 is dimensioned to allow the first wall 52 and the side walls 54 to extend from the substrate mating end 16 a further distance than the substrate mating portions 28 extend from the substrate mating end 16 of the connector housing 12.

A first latch receiving opening 56 and a second latch receiving opening 58 extend through the first wall 52 of the cover 50. The first latch receiving opening 56 and the second latch receiving opening 58 are spaced apart and are positioned in line with the latching projection 30.

A dovetail recess 60 is provided on each side wall 54. In the illustrative embodiment shown, the dovetail recesses 60 extend essentially the entire length of the cover 50. The dovetail recesses 60 have angled side walls 62. The dovetail recesses 60 are configured to allow the dovetail tracks 40 to be positioned therein, thereby allowing the dovetail tracks 40 and the dovetail recesses 60 to guide the cover 50 as the cover 50 is moved between a first latched position and a second latched position, as will be more fully described. In the illustrative embodiment, the recesses 60 have a dovetail configuration, however, other configurations of the recesses 60 may be used. The tracks 40 and the recesses 60 allow the cover 50 to be guided relative to the housing 12, regardless of the particular configuration of the tracks 40 and recesses 60.

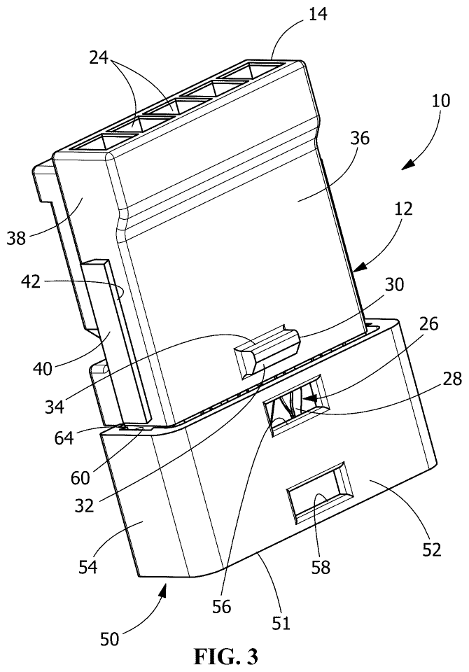

As best shown in FIG. 3, during the molding of the connector housing 12 and the cover 50, molded connection points 64 are provided periodically to allow the molding material to flow between the connector housing 12 and the cover 50 when the molding material is flowed in the mold. In the embodiment shown, the molding connection points 64 extend between ends of the side walls 54 of the cover 50 and the substrate mating end 16 of the connector housing 12. The molding connection points 64 also provide a breakable connection between the cover 50 and the connector housing 12 to maintain the cover 50 in an initial position relative to the connector housing 12.

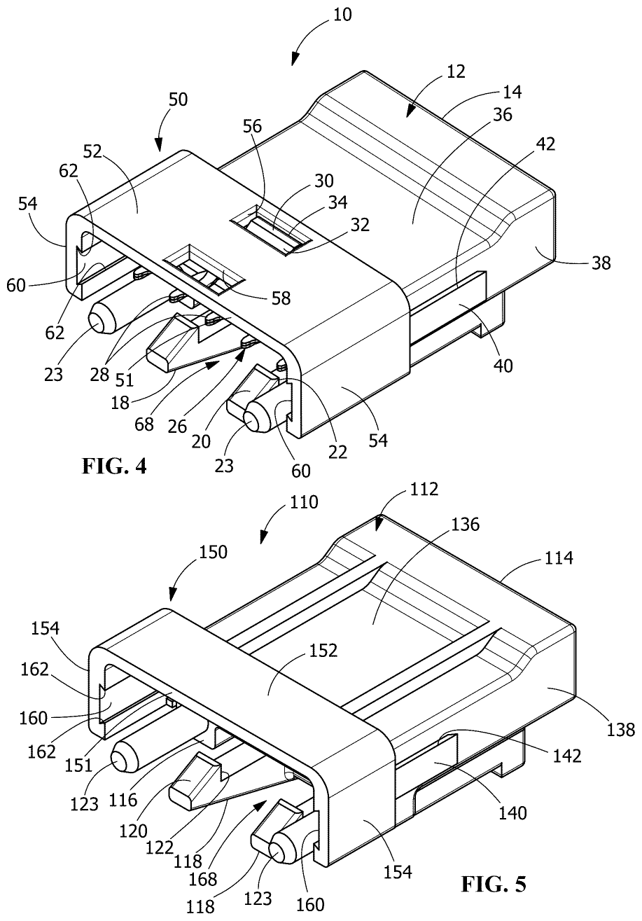

In use, the connector 10 is removed from the mold. The cover 50 is moved from the initial position, shown in FIG. 3 to the first latched position shown in FIG. 4. As this occurs, the molded connection points 64 are broken and the dovetail recess 60 of the cover 50 engage the dovetail tracks 40 of the connector housing 12 to allow the cover 50 to be guided and moved relative to the connector housing 12.

Movement continues until the latching projection 30 are positioned in the first latch receiving opening 56. In this position, the latching projection 30 cooperates with the first latch receiving opening 56 to provide a mechanical stop to maintain the cover in the first latching position until a sufficient force is applied to the cover 50.

With the cover 50 maintained in the first latching position, the contact terminals 26 are inserted into the terminal receiving cavities 24. In this position, the substrate mating portions 28 extend from the substrate mating end 16 of the connector housing 12. As the cover 50 extends beyond the substrate mating end 16 of the connector housing 12, the substrate mating portions 28 of the contact terminals 26 are provided in the opening 68 of the cover 50 provided between the first wall 52 and the side walls 54, thereby preventing unwanted engagement and damage of the contact terminals 26 during shipping and further assembly.

In alternate embodiments, the contact terminals 26 may be inserted into the terminal receiving cavities 24 prior to the cover 50 being moved from the initial position to the first latching position.

Once the connector 10 is fully assembled, the connector 10 is moved into engagement with a substrate (not shown), such as, but not limited to a panel or a printed circuit board. As this occurs, the cover 50 engages the substrate, causing the cover 50 to move toward the wire receiving end 14 of the connector housing 12. With sufficient force, the latching projection 30 is moved from the first latch receiving opening 56, allowing the cover 50 to be moved.

As the cover 50 is moved, the dovetail recess 60 of the cover 50 engage the dovetail tracks 40 of the connector housing 12 to allow the cover 50 to be guided and moved relative to the connector housing 12. Movement continues until the leading edge 51 of the cover 50 is moved into proximate alignment with the substrate mating end 16 of the connector housing 12.

In this position, the latching projection 30 cooperates with the second latch receiving opening 58 to provide a mechanical stop to maintain the cover in the second latching position. As the cover 50 does not extend beyond the substrate mating end 16 of the connector housing 12, the substrate mating portions 28 of the contact terminals 26 can freely be inserted into plated through holes of the substrate.

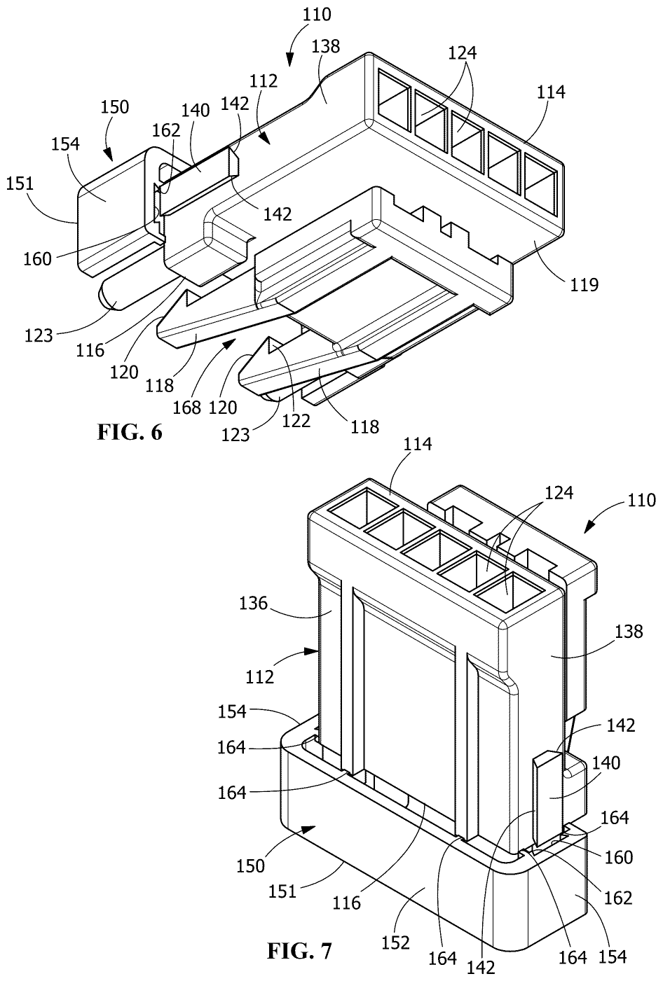

As shown in FIGS. 5 through 7, a second illustrative embodiment of a connector 110 has a connector housing 112 with a wire receiving end 114 and a substrate mating end 116. Latching arms 118 extend from proximate the wire receiving end 114 to beyond the substrate mating end 116. The latch arms 118 have lead-in surfaces 120 proximate free ends thereof. Latching shoulders 122 are provided proximate the lead-in surfaces 120. In the illustrative embodiment, two latching arms 118 are provided extending from a bottom or first wall 119 of the connector housing 112 However, other numbers and configurations of latching arms 118 may be used. In addition, the latching arms may be provided on an additional part which is mated with the connector housing.

Mounting guide projections 123 extend from the substrate mating end 116 in a direction away from the wire receiving end 114. In the illustrative embodiment, two mounting guide projections 123 are provided, however other numbers and configurations of the mounting guide projections 123 may be used.

The connector housing 112 has terminal receiving cavities 124 which extend from the wire receiving end 114 to the substrate mating end 116. Contact terminals (not shown) similar to that described above, are positioned in the terminal receiving cavities 124. The contact terminals have substrate mating portions (not shown) which extend beyond the substrate mating end 116. The contact terminals may be, but are not limited to, the type of terminals described in copending U.S. application Ser. No. 17/382,842 filed Jul. 22, 2021 and copending U.S. application Ser. No. 18/336,091 filed Jun. 16, 2023, both of which are incorporate herein by reference in their entirety.

Side walls 138 extend between first wall 119 and second wall 136 of the connector housing 112. A dovetail track 140 is provided on each side wall 138. The dovetail tracks 140 extend from proximate the substrate mating end 116 toward the wire receiving end 114. The dovetail tracks 140 have angled side walls 142 which are tapered inward toward the side walls 138. In the illustrative embodiment, the tracks 140 have a dovetail configuration, however, other configurations of the tracks 140 may be used.

A cover member 150 is provided proximate the substrate mating end 116 of the connector housing 112. The cover member 150 has a first planar wall 152 and side walls 154 which extend from the first wall 152. In the embodiment shown, the side walls 154 extend essentially perpendicular to the first wall 152. The cover member 150 is dimensioned to allow the first wall 152 and the side walls 154 to extend from the substrate mating end 116 a further distance than the substrate mating portions of the terminals extend from the substrate mating end 116 of the connector housing 112.

A dovetail recess 160 is provided on each side wall 154. In the illustrative embodiment shown, the dovetail recesses 160 extend essentially the entire length of the cover 150. The dovetail recesses 160 have angled side walls 162. The dovetail recesses 160 are configured to allow the dovetail tracks 140 to be positioned therein, thereby allowing the dovetail tracks 140 and the dovetail recesses 160 to guide the cover 150 as the cover 150 is moved between a first position and a second position, as will be more fully described. In the illustrative embodiment, the recesses 160 have a dovetail configuration, however, other configurations of the recesses 160 may be used. The tracks 140 and the recesses 160 allow the cover 150 to be guided relative to the housing 112, regardless of the particular configuration of the tracks 140 and recesses 160.

As best shown in FIG. 7, during the molding of the connector housing 112 and the cover 150, molded connection points 164 are provided periodically to allow the molding material to flow between the connector housing 112 and the cover 150 when the molding material is flowed in the mold. In the embodiment shown, the molding connection points 164 extend between ends of the side walls 154 of the cover 150 and the substrate mating end 116 of the connector housing 112. The molding connection points 164 also provide a breakable connection between the cover 150 and the connector housing 112 to maintain the cover 150 in a first position relative to the connector housing 12.

In use, the connector 110 is removed from the mold. The cover 150 is retained in the first or initial position, shown in FIG. 7 by the molded connection points 164. The cover 150 is maintained in the first or initial position until a sufficient force is applied to the cover 150.

With the cover 150 maintained in the first or initial position, the contact terminals are inserted into the terminal receiving cavities 124. In this position, the substrate mating portions extend from the substrate mating end 116 of the connector housing 112. As the cover 150 extends beyond the substrate mating end 116 of the connector housing 112, the substrate mating portions of the contact terminals are provided in the opening 168 of the cover 150 provided between the first wall 152 and the side walls 154, thereby preventing unwanted engagement and damage of the contact terminals during shipping and further assembly.

Once the connector 110 is fully assembled, the connector 110 is moved into engagement with a substrate (not shown), such as, but not limited to a panel or a printed circuit board. As this occurs, the cover 150 engages the substrate, causing the cover 150 to move toward the wire receiving end 114 of the connector housing 112. With sufficient force, the molded connection points 164 are broken and the cover is moved.

As the cover 150 is moved, the dovetail recess 160 of the cover 150 engage the dovetail tracks 140 of the connector housing 112 to allow the cover 150 to be guided and moved relative to the connector housing 112 from the first or initial position to a second or final position. Movement continues until the leading edge 151 of the cover 150 is moved into proximate alignment with the substrate mating end 116 of the connector housing 112. As the cover 150 does not extend beyond the substrate mating end 116 of the connector housing 112, the substrate mating portions of the contact terminals can freely be inserted into plated through holes of the substrate.

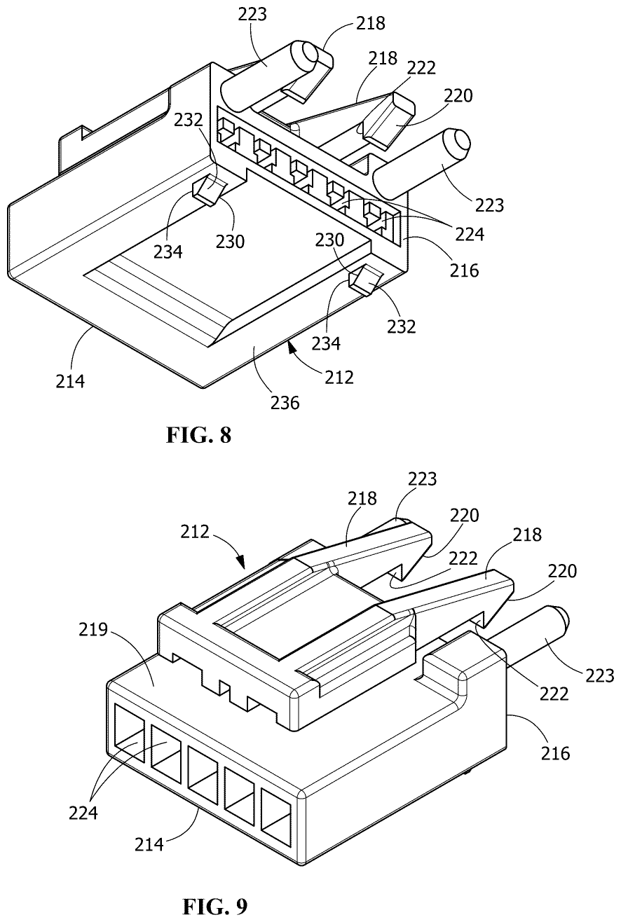

As shown in FIGS. 8 through 11, a third illustrative embodiment of a connector 210 has a connector housing 212 with a wire receiving end 214 and a substrate mating end 216. Latching arms 218 extend from proximate the wire receiving end 214 to beyond the substrate mating end 216. The latch arms 218 have lead-in surfaces 220 proximate free ends thereof. Latching shoulders 222 are provided proximate the lead-in surfaces 220. In the illustrative embodiment, two latching arms 218 are provided extending from a bottom or first wall 219 of the connector housing 212. However, other numbers and configurations of latching arms 218 may be used. In addition, the latching arms may be provided on an additional part which is mated with the connector housing.

Mounting guide projections 223 extend from the substrate mating end 216 in a direction away from the wire receiving end 214. In the illustrative embodiment, two mounting guide projections 223 are provided, however other numbers and configurations of the mounting guide projections 223 may be used.

The connector housing 212 has terminal receiving cavities 224 which extend from the wire receiving end 214 to the substrate mating end 216. Contact terminals (not shown) similar to that described above, are positioned in the terminal receiving cavities 224. The contact terminals have substrate mating portions (not shown) which extend beyond the substrate mating end 216. The contact terminals may be, but are not limited to, the type of terminals described in copending U.S. application Ser. No. 17/382,842 filed Jul. 22, 2021 and copending U.S. application Ser. No. 18/336,091 filed Jun. 16, 2023, both of which are incorporate herein by reference in their entirety.

The connector housing 212 has latching projections 230 positioned between the wire receiving end 214 and the substrate mating end 216, proximate the substrate mating end 216. The latching projections 230 have lead-in surfaces 232 and latching shoulders 234. In the illustrative embodiment, two latching projections 230 is provided on a top or second wall 236 of the connector housing 212 which is opposed to the first wall 219 from which the latching arms 218 extend. However, other numbers and configurations of the latching projection 230 may be used.

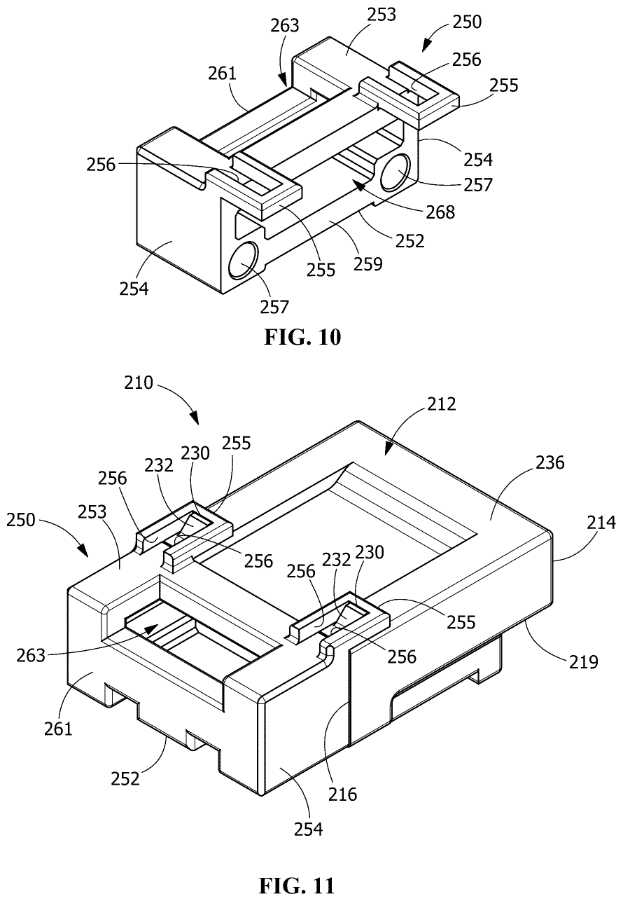

As shown in FIGS. 10 and 11, a cover member 250 is provided proximate the substrate mating end 216 of the connector housing 212. The cover member 250 has a first planar wall 252, a second planar wall 253 and side walls 254 which extend between the first wall 252 and the second wall 253. In the embodiment shown, the side walls 254 extend essentially perpendicular to the first wall 252 and the second wall 252. The cover member 50 is dimensioned to allow the first wall 252, the second wall 253 and the side walls 254 to extend from the substrate mating end 216 a further distance than the substrate mating portions of the contact terminals extend from the substrate mating end 216 of the connector housing 212.

Latch receiving projections 255 extend from the second wall 253. The latch receiving projections 255 have latch receiving openings or slots 256 which extend therethrough.

Mounting guide projection receiving openings 257 extend from a leading surface 259 of the cover 250 toward a rear surface 261. The mounting guide projection receiving openings 257 are dimensioned to receive the mounting guide projections 223 therein.

An opening 263 is provided in the second wall 253. The opening 263 extends into a terminal receiving opening 268 of the cover 250 which extends between the first wall 252, the second wall 253 and the side walls 254.

In use, the contact terminals are inserted into the terminal receiving cavities 224. In this position, the substrate mating portions of the contact terminals extend from the substrate mating end 216 of the connector housing 212.

The cover 250 is positioned on the connector housing 212 in a manner to protect the contact terminals. The cover 250 is moved into engagement with the substrate mating end 216 of the connector housing 212, positioning the substrate mating portions of the contact terminals in the opening 268 of the cover 250. When positioned properly, the cover 250 prevents unwanted engagement and damage of the contact terminals during shipping and further assembly.

As the cover 250 is moved into position, the mounting guide projections 223 of the connector housing 212 are positioned in the mounting guide projection receiving openings 257 of the cover 250. The mounting guide projections 223 and the mounting guide projection receiving openings 257 cooperate to properly guide and move the cover 250 relative to the connector housing 212.

When properly positioned, the latching projections 230 are positioned in the latch receiving openings or slots 256 of the latch receiving projections 255 to detachably secure to the cover 250 to the connector housing 212. This allows the cover 250 to be retained on the connector housing 212 until the cover 250 is removed by the user.

Prior to the connector 210 being moved into engagement with a substrate (not shown), such as, but not limited to a panel or a printed circuit board, the cover 250 is removed from the connector housing 212. With the cover 250 removed, the substrate mating portions of the contact terminals can freely be inserted into plated through holes of the substrate.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A connector assembly comprising:
a connector housing having terminal receiving cavities which extend to a mating end of the connector housing;
electrical terminals provided in the terminal receiving cavities, the terminals having mating portions which extend from the terminal receiving cavities beyond the mating end of the electrical connector;
a movable cover movably mounted on the connector housing, the movable cover extending over the mating portions of the terminals;
wherein the movable cover prevents unwanted engagement and damage to the mating portions of the terminals during shipping and assembly.

2. The connector assembly as recited in claim 1, wherein the movable cover has a first wall and side walls which extend from the first wall, the first wall and the side walls extend from the mating end a further distance than the mating portions of the terminals extend from the mating end of the connector housing when the movable cover is in an initial position.

3. The connector assembly as recited in claim 2, wherein a latching projection is provided on the connector housing proximate the mating end.

4. The connector assembly as recited in claim 3, wherein a first latch receiving opening and a second latch receiving opening extend through the first wall of the cover, the first latch receiving opening and the second latch receiving opening are spaced apart and are positioned in line with the latching projection.

5. The connector assembly as recited in claim 2, wherein tracks are provided on side walls of the connector housing, the tracks extend from proximate the mating end.

6. The connector assembly as recited in claim 5, wherein recesses are provided on the side walls of the cover.

7. The connector assembly as recited in claim 6, wherein the tracks have a dovetail configuration in which side walls of the tracks are tapered inward toward the side walls of the connector housing.

8. The connector assembly as recited in claim 7, wherein the recesses have a dovetail configuration, the recesses are configured to allow the tracks to be positioned therein, thereby allowing the tracks and the recesses to guide the cover as the cover is moved between a first latched position and a second latched position.

9. The connector assembly as recited in claim 8, wherein the recesses have angled side walls and extend essentially the length of the cover.

10. The connector assembly as recited in claim 4, wherein the cover is initially attached to the connector housing by molded connection points which extend between ends of the cover and the mating end of the connector housing.

11. The connector assembly as recited in claim 10, wherein the molding connection points provide a breakable connection between the cover and the connector housing to maintain the cover in an initial position relative to the connector housing.

12. The connector assembly as recited in claim 1, wherein the cover is initially attached to the connector housing by molded connection points which extend between ends of the cover and the mating end of the connector housing.

13. The connector assembly as recited in claim 12, wherein the movable cover has a first wall and side walls which extend from the first wall, the first wall and the side walls extend from the mating end a further distance than the mating portions of the terminals extend from the mating end of the connector housing when the movable cover is in an initial position.

14. The connector assembly as recited in claim 13, wherein tracks are provided on side walls of the connector housing, the tracks extend from proximate the mating end.

15. The connector assembly as recited in claim 14, wherein recesses are provided on the side walls of the cover.

16. The connector assembly as recited in claim 15, wherein the tracks have a dovetail configuration in which side walls of the tracks are tapered inward toward the side walls of the connector housing.

17. The connector assembly as recited in claim 16, wherein recesses have a dovetail configuration, the recesses have angled side walls and extend essentially the length of the cover, the recesses are configured to allow the tracks to be positioned therein, thereby allowing the tracks and the recesses to guide the cover as the cover is moved between a first latched position and a second latched position.

18. The connector assembly as recited in claim 1, wherein the connector housing has mounting guide projections which extend from the mating end and latching projections positioned between the mating end.

19. The connector assembly as recited in claim 18, wherein the movable cover has a first wall, a second wall and side walls which extend between the first wall and the second wall, latch receiving projections extend from the second wall of the cover, the latch receiving projections have latch receiving openings which extend therethrough, mounting guide projection receiving openings extend from a leading surface of the cover toward a rear surface of the cover, the mounting guide projection receiving openings are dimensioned to receive the mounting guide projections therein.

20. The connector assembly as recited in claim 19, wherein the movable cover is dimensioned to allow the first wall, the second wall and the side walls to extend from the substrate mating end a further distance than the mating portions of the terminals extend from the mating end of the connector housing, an opening is provided in the second wall, the opening extends into a terminal receiving opening of the cover which extends between the first wall, the second wall and the side walls.
